(19) United States
(12) Patent Application Publication
(10) Pub. No.: US 2025/0238017 A1
(43) Pub. Date: Jul. 24, 2025

(54) METHOD FOR SWITCHING BETWEEN OPERATIONAL MODES IN TELE-MANUFACTURING SYSTEMS

(71) Applicant: Edison Welding Institute, Inc., Columbus, OH (US)

(72) Inventors: Constance Reichert LaMorte, Columbus, OH (US); Paul A. Blomquist, Wells, ME (US); Timothy A. Moore, Columbus, OH (US); James D. Farrell, Columbus, OH (US)

(21) Appl. No.: 18/420,089

(22) Filed: Jan. 23, 2024

(51) Int. Cl. G05B 19/4155; G06F 3/0484

(52) U.S. Cl. CPC G05B 19/4155; G06F 3/0484; G05B 2219/45135

(57) ABSTRACT

A method for switching between operational modes in a tele-manufacturing system, comprising providing a tele-manufacturing system having manufacturing equipment and sensors positioned in a manufacturing environment, a manual controller that receives motion input from a user of the controller, and a processor with control software that mathematically transforms the motion input into corresponding motion commands sent to the manufacturing equipment; connecting the processor to equipment and the controller; and configuring the processor to display action choices on a main screen user interface that include activating a free form mode that enables the user to move the manufacturing equipment at will; and activating a path mode that directs the equipment to perform manufacturing commands; navigate the user to a first screen if the free form mode is activated; and a second screen if the path mode is activated; and automatically switch between the free form mode and the path mode.

### BACKGROUND

The disclosed technology relates in general to industrial manufacturing and fabricating systems operated from a remote location, also referred to as a “tele-manufacturing” systems, and more specifically to systems, devices, and methods for switching between operational modes in tele-manufacturing systems.

As an industrial process, weld inspection (and industrial welding generally) is currently challenged by a variety of factors including a decreasing number of skilled users; a lack of individuals wanting to enter what are traditionally considered to be “manual” trades; and an ever-increasing list of hazards and limitations related to welding, grinding, and other hot work activities that make finding and keeping experienced users difficult. Additionally, efforts within industry to optimize weight and space in manufacturing processes have resulted in the construction of manufacturing facilities that are basically inaccessible to humans. Accordingly, there is an ongoing need for welding-related systems, processes, and methods that permit qualified users to enter and remain in the workforce regardless of physical limitations, age, or other perceived obstacles such as those described above.

### SUMMARY

The following provides a summary of certain example implementations of the disclosed technology. This summary is not an extensive overview and is not intended to identify key or critical aspects or elements of the disclosed technology or to delineate its scope. However, it is to be understood that the use of indefinite articles in the language used to describe and claim the disclosed technology is not intended in any way to limit the described technology. Rather the use of “a” or “an” should be interpreted to mean “at least one” or “one or more”.

One implementation of the disclosed technology provides a method for switching between operational modes in tele-manufacturing systems, wherein the tele-manufacturing systems comprise manufacturing equipment and at least one sensor positioned in a manufacturing environment, at least one manual controller that receives motion input from a user of the manual controller, and at least one processor with control software that mathematically transforms the motion input into corresponding motion commands that are sent to the manufacturing equipment. The method comprises connecting the at least one processor to the manufacturing equipment and the at least one manual controller; and configuring the at least one processor to display a plurality of action choices to the user on a main screen user interface, wherein the plurality of action choices comprises activating a free form mode, wherein the free form mode enables the user to move the manufacturing equipment at will; and activating a path mode, wherein the path mode directs the manufacturing equipment to perform manufacturing commands; navigate the user to a first screen if the user chooses to activate the free form mode; and a second screen if the user chooses to activate the path mode; and automatically switch between the free form mode and the path mode.

Within the first screen, the processor is configured to enable the free form mode upon the user's command; display real-time video data of the free form mode to the user; and direct the user to the second screen if the user chooses to activate the path mode. The processor directs the user back to the main screen user interface if the user does not enable the free form mode. Within the second screen, the processor is configured to receive the manufacturing commands and manufacturing parameter data from the user; and direct the user to a live manufacturing screen if the user is ready for the manufacturing equipment to perform the manufacturing commands. The processor directs the user back to the main screen user interface if the user is not ready for the manufacturing equipment to perform the manufacturing commands. Within the live manufacturing screen, the processor is configured to display real-time video data of the path mode to the user; activate the manufacturing equipment in the manufacturing environment; and deactivate the manufacturing equipment when a manufacturing end-point is reached. The processor displays a countdown to the user before activating the manufacturing equipment in the manufacturing environment. The user can selectively abort the countdown and prevent the processor from activating the manufacturing equipment. The plurality of action choices further comprises changing the at least one manual controller. The processor is further configured to navigate the user to a third screen if the user chooses to change the at least one manual controller. Within the third screen, the processor is configured to display all available manual controller options to the user; receive user selection of a new manual controller from the available manual controller options; connect the new manual controller to the processor; and direct the user back to the main screen user interface once the new manual controller is connected. The processor directs the user back to the main screen user interface if the user chooses not to change the selected manual controller. The manufacturing equipment may include welding equipment or other equipment.

Another implementation of the disclosed technology provides a method for switching between operational modes in tele-manufacturing systems, wherein the tele-manufacturing systems comprise manufacturing equipment and at least one sensor positioned in a manufacturing environment, at least one manual controller that receives motion input from a user of the manual controller, and at least one processor with control software that mathematically transforms the motion input into corresponding motion commands that are sent to the manufacturing equipment. The method comprises connecting the at least one processor to the manufacturing equipment and the at least one manual controller, wherein the at least one processor is configured to display a plurality of action choices to the user on a main screen user interface, wherein the plurality of action choices comprise activating a free form mode, wherein the free form mode enables the user to move the manufacturing equipment at will; activating a path mode, wherein the path mode directs the manufacturing equipment to perform manufacturing commands; and changing the at least one manual controller; navigate the user to a first screen if the user chooses to activate the free form mode; a second screen if the user chooses to activate the path mode; and a third screen if the user chooses to change the at least one manual controller; and automatically switch between the free form mode and the path mode.

Within the first screen, the processor is configured to enable the free form mode upon the user's command; display real-time video data of the free form mode to the user; and direct the user to the second screen if the user chooses to activate the path mode. Within the second screen, the processor is configured to receive the manufacturing commands and manufacturing parameter data from the user; and direct the user to a live manufacturing screen if the user is ready for the manufacturing equipment to perform the manufacturing commands. Within the live manufacturing screen, the processor is configured to display real-time video data of the path mode to the user; activate the manufacturing equipment in the manufacturing environment; and deactivate the manufacturing equipment when a manufacturing end-point is reached. The processor displays a countdown to the user before activating the manufacturing equipment in the manufacturing environment. Within the third screen, the processor is configured to display all available manual controller options to the user; receive user selection of a new manual controller from the available manual controller options; connect the new manual controller to the processor; and direct the user back to the main screen user interface once the new manual controller is connected. The manufacturing equipment may include welding equipment or other equipment.

It should be appreciated that all combinations of the foregoing concepts and additional concepts discussed in greater detail below (provided such concepts are not mutually inconsistent) are contemplated as being part of the technology disclosed herein and may be implemented to achieve the benefits as described herein. Additional features and aspects of the disclosed system, devices, and methods will become apparent to those of ordinary skill in the art upon reading and understanding the following detailed description of the example implementations. As will be appreciated by the skilled artisan, further implementations are possible without departing from the scope and spirit of what is disclosed herein. Accordingly, the descriptions provided herein are to be regarded as illustrative and not restrictive in nature.

### BRIEF DESCRIPTION OF THE DRAWINGS

The accompanying drawings, which are incorporated into and form a part of the specification, schematically illustrate one or more example implementations of the disclosed technology and, together with the general description given above and detailed description given below, serve to explain the principles of the disclosed subject matter, and wherein:

FIG. 1 is a simplified block diagram of an example implementation a tele-manufacturing system configured for welding showing the basic components of the system and the location of the components relative to one another;

FIG. 2 is a flow chart of an example method for implementing multi-mode switching functionality in the tele-manufacturing system of FIG. 1;

FIG. 3 is a flow chart of an example stepwise process for enabling a specific mode (i.e., jogging mode) of the tele-manufacturing system of FIG. 1;

FIG. 4 is a flow chart of an example stepwise process for changing a manual controller within the tele-manufacturing system of FIG. 1;

FIG. 5 is a flow chart of an example process for setting welding parameters within the tele-manufacturing system of FIG. 1;

FIG. 6 is a flow chart of an alternate example stepwise process for setting welding parameters within the tele-manufacturing system of FIG. 1; and

FIG. 7 is a flow chart of an example stepwise process for performing live welding within the tele-manufacturing system of FIG. 1.

### DETAILED DESCRIPTION

Example implementations are now described with reference to the Figures. Reference numerals are used throughout the detailed description to refer to the various elements and structures. Although the following detailed description contains many specifics for the purposes of illustration, a person of ordinary skill in the art will appreciate that many variations and alterations to the following details are within the scope of the disclosed technology. Accordingly, the following implementations are set forth without any loss of generality to, and without imposing limitations upon, the claimed subject matter.

The examples discussed herein are examples only and are provided to assist in the explanation of the apparatuses, devices, systems, and methods described herein. None of the features or components shown in the drawings or discussed below should be taken as required for any specific implementation of any of these the apparatuses, devices, systems or methods unless specifically designated as such. For ease of reading and clarity, certain components, modules, or methods may be described solely in connection with a specific Figure. Any failure to specifically describe a combination or sub-combination of components should not be understood as an indication that any combination or sub-combination is not possible. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

U.S. Patent Publication No. 2023/0112463 is relevant to the disclosed technology and the entire contents thereof are expressly incorporated by reference herein and made part of this patent application for all purposes. U.S. Patent Publication No. 2023/0112463 discloses tele-manufacturing and tele-welding systems and methods that enable the operation of industrial equipment from one or more locations that are physically remote from the environment in which manufacturing is occurring. Tele-operation is most commonly associated with robotics and mobile robots, but may be applied to an entire range of circumstances in which a device or machine is operated by a person from a distance. Tele-welding systems permit an individual to direct a welding process from a remote location by controlling welding arc on, welding arc off, welding travel speed, and welding torch angles and motions, thereby permitting the individual to make various decisions regarding the welding of a part that is not in their immediate visual or auditory range.

Tele-welding and tele-manufacturing differ from remote welding and programming in that the welding and weld-programming machinery at the remote location (e.g., robot, manipulator, mechanization, automation, etc.) is not running an independent program or motion plan. The person (operator) who is remote from the machinery is in direct control of the welding and weld-programming machinery and makes decisions to move the machinery by use of a hand-held stylus device or similar device. Furthermore, tele-manufacturing systems differ from virtual reality (VR) in that the hand-held stylus is an actual physical device that has various degrees of rotational freedom and provides encoded position information from each axis when queried and converts the motion of the stylus device into motion on a live articulated machine (robot) with various degrees of rotational freedom. Regarding the local manipulator (e.g., stylus) to remote machinery (e.g., robot) motion in implementations wherein the stylus (controller) and articulated machine (robot) both include six degrees of freedom, the robot six degrees of freedom includes X, Y, Z, roll, pitch and yaw (Rx, Ry, Rz) direction motions generated with the six coordinated axes of the articulated robot. The six degrees of freedom of the stylus device include X, Y and Z direction motion and three additional gimbaled axes that provide the additional three degrees of freedom.

Tele-welding and tele-manufacturing systems differ from off-line planning control systems in that motion control is done in real-time with only sub-second delays or latency between user movement of the hand-held stylus and motion produced on remote machinery. The difference between the disclosed control systems and a traditional master-follower control system is that the degrees of freedom of motion on the stylus do not produce the same degrees of freedom motion result on the robot, i.e., the motion output of the robot and hand-held stylus are not identical. Additionally, the number of degrees of freedom present on the hand-held stylus device (or other type of controller) does not necessarily match the number of degrees of freedom on the robot.

The disclosed technology utilizes components similar to that of the tele-welding system described in U.S. Patent Publication No. 2023/0112463 and provides a method for switching between a tele-controlled jogging mode and a tele-controlled robot path mode. The jogging mode enables a local user to move a remote robot at will, in any direction until the user is ready to perform the welding process. When the user is ready to weld, the control software automatically switches to the robot path mode and directs the remote robot to perform welding commands, including welding are on, welding arc off, weld travel direction, weld travel speed, weld weave width, weld weave speed, weave orientation with respect to the face of a weld, torch travel angle, torch height control, torch workpiece angle, torch tip roll, and specific motions related to weld joint type. It is to be understood that the disclosed technology is not so limited to tele-welding systems, but can also include other tele-manufacturing systems such as tele-grinding, tele-gouging, tele-inspection, and tele-programming.

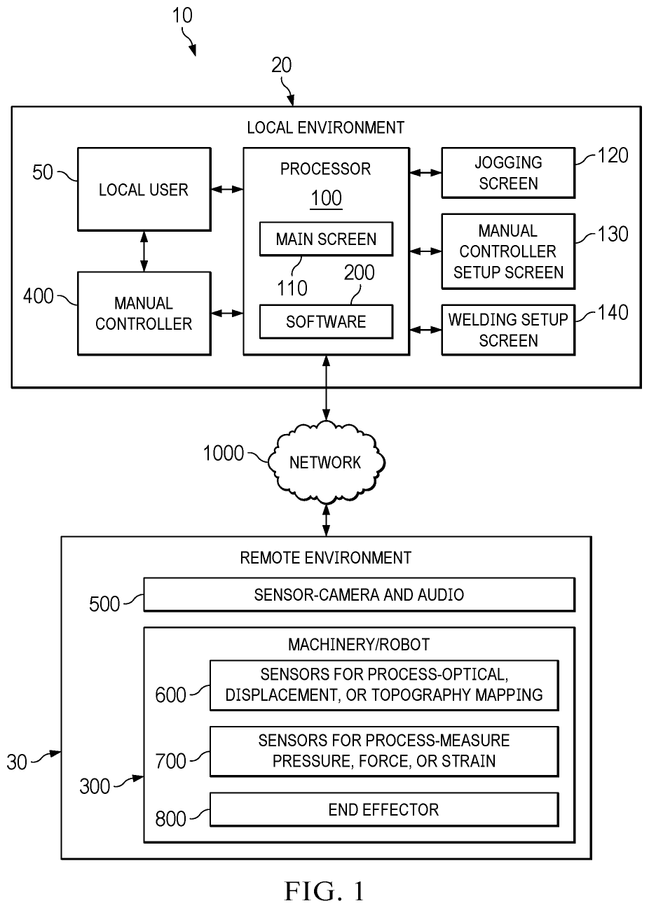

FIG. 1 provides a block diagram of an example implementation of a tele-welding system that includes multi-mode switching functionality. With reference to FIG. 1, tele-welding system 10 includes various components that when used together allow local user 50, who is in direct contact with manual controller 400, to control welding machinery 300 that performs manual movements based on and coordinated with the movements of manual controller 400, despite machinery 300 being located in remote environment 30, which is physically separate from local user 50 in local environment 20. User 50 may also freely switch between a tele-controlled jogging mode and a tele-controlled robot path mode. An example implementation of tele-welding system 10 includes processor 100 having main screen 110; jogging screen 120; manual controller set-up screen 130; welding set-up screen 140; control software 200; remote machinery 300; manual controller 400; environmental sensors 500; three-dimensional scanning sensors 600; process sensors 700; and end effector 800.

Processor 100, which may be a computer or computing device that includes control hardware, runs an overall program for communicating with remote devices over network 1000 using wired or wireless protocols. Processor 100 is connected to manual controller 400, which may be a hand-held stylus, joystick, mouse, or any other electronic or computer-compatible motion control device having at least one degree of rotational freedom. Processor 100 allows local user 50 to navigate between screens 120, 130, 140 and to simultaneously interact with locally connected manual controller 400 and remote machinery/robot 300. Processor 100 is connected to the Internet and opens a URL/webpage or digital media player software using an Internet browser or similar program. In some implementations, other open or closed computer networks are utilized.

In some implementations, jogging screen 120 is communicatively coupled to processor 100 for allowing local user 50 to enable jogging mode and select specific action for the robot. In some implementations, manual controller setup screen 130 is communicatively coupled to processor 100 for permitting local user 50 to select and connect a new manual controller to tele-welding system 10. In some implementations, welding setup screen 140 is communicatively coupled to processor 100 for allowing local user 50 to select welding positions and set welding parameters. Main screen 110 on processor 100 provides real-time feedback of video and audio of remote environment 30 to local user 50. Jogging screen 120, manual controller screen 130, and welding setup screen 140 are all navigable from main screen 110 of processor 100.

Control software 200 runs on processor 100 and enables communication with and between remote machinery 300 across network 1000. In an example implementation, control software 200 uses digitized environmental data (e.g., point clouds) provided by three-dimensional scanning sensors 600 (such, for example, as laser detection and ranging (LIDAR), blue, white, or stereo scanning sensors), and mathematical transformations to convert a digital environment into haptic feedback felt by local user 50 while holding manual controller 400, in real time, thereby providing local user 50 with a physical sense of an actual working environment. Control software 200 also allows local user 50 to initiate or stop communication with remote machinery 300. Remote machinery 300 can include any type of welding equipment, measurement equipment, inspection equipment, remote assembly equipment, or a combination thereof, including a robot or robot controlled having a process tool end effector. Process tool end effector 800 can be any instrument or tool used in manufacturing processes including, but not limited to, grinders or similar material removal devices, weld torches, and inspection probes. The robot and robot controller hardware are typically controlled by open source or proprietary communication protocols.

Control software 200, an example of which is specific to tele-welding system 10, includes an executable application that can be run on the computer of a remote user, on a computer located in the same environment as machinery 300, or on the robot controller system. Software 200 provides a connection to remote machinery 300 using a local area network (LAN), intranet, or the Internet, (collectively, network 1000) for the purpose of controlling remote machinery 300. Software 200 receives input from user 50 by way of the user interface or HMI screen 150 to begin or end a tele-grinding process, to set or change process settings or parameters, or to set or change manual controller 400 parameters. System software 200 provides a process for communicating with at least one locally connected manual controller 400, thereby allowing user 50 to directly manipulate manual controller 400 while querying manual controller 400 positions and converting the positions to resultant movement of the remote machinery 300. In other implementations, the welding start/stop process is accomplished using buttons or other additional data input/output features included on manual controller 400.

Controller 400 may be a manually operated device such as a hand-held stylus, a computer mouse, a joystick, or any other suitable device having at least one degree of rotational freedom that can be used to record various hand motions of user 50. Physical manipulations of manual controller 400 by user 50 are ultimately converted into the physical motions of remote machinery 300 by control software 200. Manual controller 400 may also provide a haptic feedback response to user 50, corresponding to either physical environmental objects that exist at the remote location or to virtual barriers.

Manual controller 400 may be a stylus device that is a commercially available haptic feedback system including software libraries that are imported into tele-welding software program 200. For example, tele-welding software 200 queries manual controller/stylus device 400 using stylus software library functions for current axis positions and tele-welding software 200 sets the haptic feedback response of manual controller/stylus device 400 by sending commands to manual controller/stylus device 400 using the stylus software library functions. Manual controller/stylus device 400 applies the commanded settings from tele-welding software 200 to produce a sensation response felt by local user 50 holding manual controller/stylus device 400. The commanded settings change the servo-motor power and response characteristics which produce sensations of touching surfaces of different densities or at differing levels of force, mass, gravity or speed. Tele-welding software 200 determines the settings for the type of response based on the current location of remote machinery 300 and from analysis of the data queried from sensors 500, 600, and 700.

The resultant motion performed on remote machinery 300 is with respect to the welding position. American Welding Society (AWS) welding joint positions for a typical groove weld of 1G, 2G, 3G, or 4G are selected by the user before beginning a welding process using tele-welding system 10. Alternately, all welding positions can be automatically calculated using sensor data for determining a current welding position and joint type. The type of weld joint is a variable used by tele-welding software program 200 to determine the parameters required for the translation and rotation of manual controller 400 into the resultant motion on remote machinery 300 and with respect to the welding position of the weld joint.

Environmental sensors 500 may include cameras, microphones, digitizers, and other types of sensing devices, and may use optical systems, devices, and methods for determining the displacement of physical objects within remote working environment 30 that encompasses remote machinery 300 and the tele-welding process that is occurring therein. Environmental sensors 500 may also use auditory systems, devices, and methods for capturing sounds within remote working environment 30 that encompasses remote machinery 300 and the tele-welding process that is occurring therein. Sensors 500, 600, and 700 may be used to collect digitized environmental data (e.g., point clouds) that is transmitted to and stored on processor 100. This digital environmental data is then used to determine when, how, and what type of physical sensation response is to be applied to the manual controller 400 for indicating the presence of a physical object in remote working environment 30 or proximity to a physical object or virtual barrier. With regard to welding processes: (i) inexpensive, digital cameras may be used to assist with proper line-up and weld placement; (ii) specialty arc welding process cameras may be used to provide a real-time weld puddle view; (iii) microphones may be used to add arc sounds to enable an experienced welder to create acceptable welds remotely; and (iv) livestreaming camera video and audio may be used to provide low latency real-time process data.

Three-dimensional sensors 600, which cooperate with environmental sensors 500, may be mounted to machinery and/or robot 300 to measure the displacement of objects relative to the sensors themselves, and provide a digitized topographical representation of the physical environment in which the welding process is occurring. Optically-based processes such as, for example, infrared (IR), laser detection and ranging (LIDAR), blue, white, or laser vibrometer scanning systems can be used to create a point cloud or three-dimensional digital map of remote working environment 30. Scanning and digitizing may be completed prior to the welding process or may be completed in real-time as the welding process is occurring. Local user 50 may provide tele-welding control software 200 with a specified maximum value or amount of weld part surface intended to be removed. With regard to welding processes, scanning and digitizing the manufacturing environment may be used to: (i) send weld joint shapes to the system for enabling haptic response to the scanned area; (ii) alert the user of upcoming joint variation or obstacles in the weld path; and (iii) send the weld joint location to the system for aligning robots and remote manipulators to the same reference plane and field of view. Process sensors 700, which cooperate with sensors 500 and 600, may be mounted to machinery/robot 300 to measure pressure, force, and/or strain applied between the weld torch and the weld surface.

Tele-welding system 10 provides real-time video and audio feedback of remote working environment 30 to user 50 in local environment 20. Video, audio, or other sensor data is encoded using commercially available encoding hardware servers or an encoding software program running on a processor. The server or processor, using commercially available software, publishes the encoded video and audio or other data stream to the internet or a LAN through a URL or web address 1000. The published livestream uses a low latency protocol to stream the information to devices over the internet or on a local area network (LAN) 1000. User 50 can access livestreamed video over the internet or LAN 1000 using a processor (e.g., a personal computer) and commercial media player application that can read and play the audio or video stream on a personal computer.

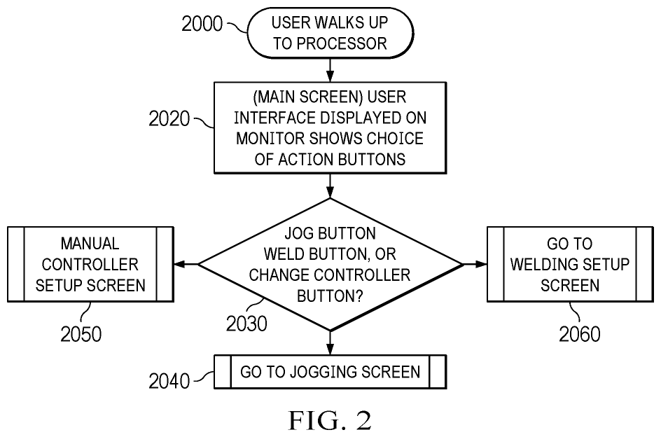

FIG. 2 is a flow chart of an example method for implementing multi-mode switching functionality in tele-welding system 10. Initially, a local user approaches a processor (at step 2000) that has a user interface displaying choice of action buttons to the user on a main screen at step 2020. From the main screen at step 2020, the local user selects one of the choice of action buttons corresponding to a jog mode, an option to change a manual controller, or a weld mode at decision step 2030. Tele-welding software navigates the user to: (i) a jogging screen at step 2040 if jog mode is selected; (ii) a manual controller setup screen at step 2050 if change to the manual controller is selected; or (iii) a welding setup screen at step 2060 if weld mode is selected. It is to be understood that the disclosed multi-mode switching is not so limited to tele-welding systems, but can also include other tele-manufacturing systems such as tele-grinding, tele-gouging, tele-inspection, and tele-programming systems.

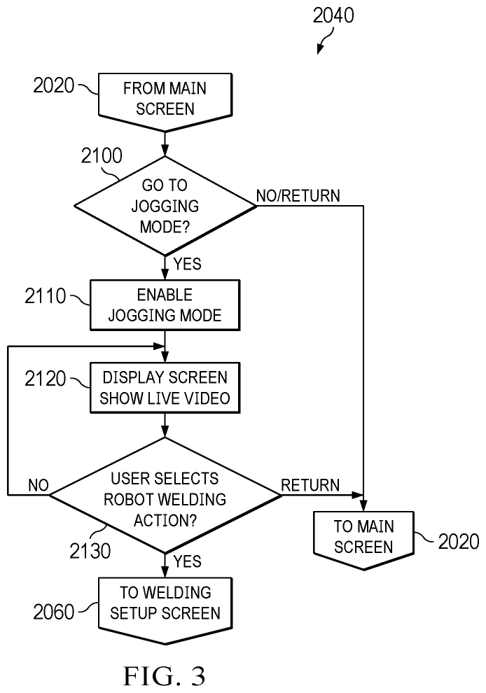

FIG. 3 is a flow chart depicting process 2040 for enabling “jog mode” on a remote robot 300. Local user navigates from the main screen to the jogging screen at step 2020 and is prompted whether to continue to jogging mode at step 2100. If the user declines to continue, the software directs the user back to the main screen. If jogging mode is enabled at step 2110, a display screen displays live video of the robot's movements in the welding environment to the local user at step 2120. The user then decides whether to select robot welding action at decision step 2130. If the user declines to select robot welding action, the process returns to step 2120. Alternatively, the user has the option to return to the main screen (step 2020). If the user selects robot welding action, the software navigates the user to the welding setup screen (step 2060).

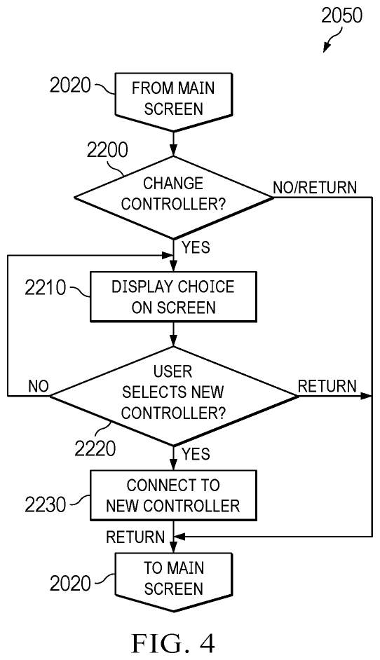

FIG. 4 is flow chart depicting process 2050 for changing the manual controller on the manual controller setup screen. After the software navigates the local user from the main screen at step 2020 to the setup screen of step 2050, the user is prompted to change or not change the manual controller at decision step 2200. If the user declines to change the manual controller, the software directs the user back to the main screen (step 2020). Alternatively, the user has the option to return to the main screen (step 2020) from decision step 2200. If the user selects to change the manual controller, manual controller choices are then displayed to the user on the display screen at step 2210. At decision step 2220, the user may: (i) select a new manual controller from the choices displayed at step 2210 and connect the new manual controller to the processor at step 2230; (ii) return to the main screen of step 2020; or (iii) decline to select a new manual controller and return the process to step 2210. If the user connects the new manual controller to the processor at step 2230, the software returns the user to the main screen (step 2020).

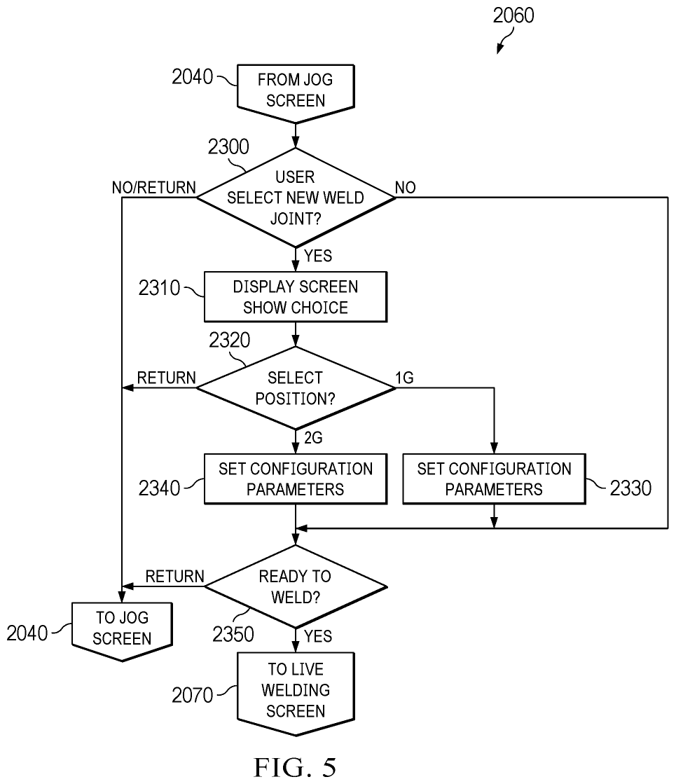

FIG. 5 is a flowchart depicting process 2060 for setting welding parameters on the welding setup screen from the jogging screen beginning at step 2040. The user is prompted whether or not to select a new weld joint in the welding environment at step 2300. The user may: (i) return to the jogging screen at step 2040; (ii) select a new weld joint; or (iii) decline to select a new weld joint. The display screen shows the chosen weld joint in the welding environment to the user at step 2310. The user selects the positioning of the weld joint at decision point 2320. The user can select from 1G welding (flat welding position) or 2G welding (horizontal welding position). Alternately, the user has the option to return to the jogging screen (step 2040) at step 2320. 1G welding parameters are set at step 2330, and 2G welding parameters are set at step 2340. Once the welding parameters are set at step 2330 or step 2340, or the user declines to select a new weld joint at decision step 2300, the software queries whether or not the user is ready to weld at step 2350. If ready, the software directs the user to a live welding screen at step 2070. If not ready, the user is returned to the jogging screen (step 2040).

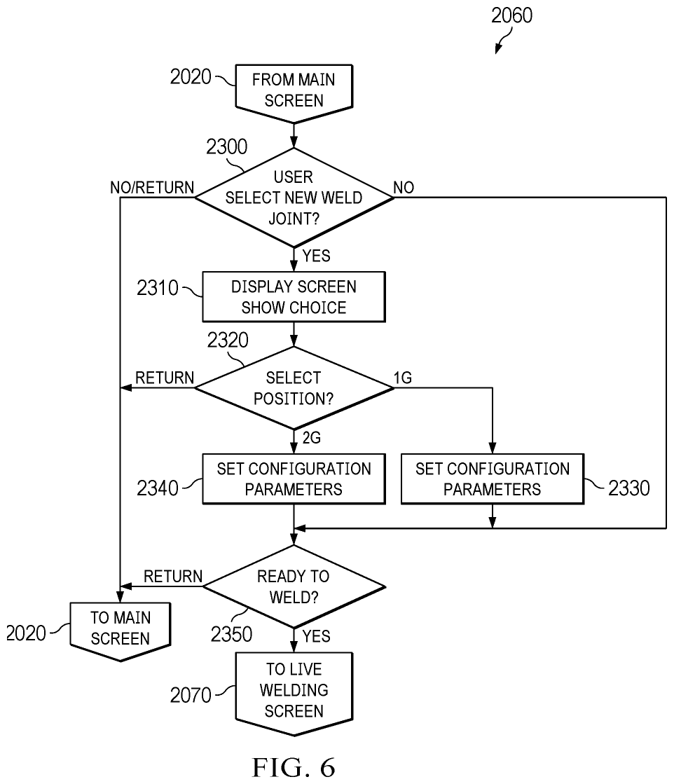

FIG. 6 is a flowchart depicting alternate process 2060 for setting welding parameters on the welding setup screen from the main screen beginning at step 2020. The user is prompted whether to select a new weld joint in the welding environment at decision step 2300. The user may: (i) return to the main screen of step 2020; (ii) select a new weld joint; or (iii) decline to select a new weld joint. The display screen shows the chosen weld joint in the welding environment to the user at step 2310. The user selects the positioning of the weld joint at step 2320. The user can select from 1G welding (flat welding position) or 2G welding (horizontal welding position). Alternately, the user has the option to return to the main screen (step 2020) at step 2320. 1G welding parameters are set at step 2330, and 2G welding parameters are set at step 2340. Once the welding parameters are set at step 2330 or step 2340, or the user declines to select a new weld joint at decision step 2300, the software queries whether or not the user is ready to weld at step 2350. If ready, the software navigates the user to the live welding screen at step 2070. If not ready, the user is returned to the main screen (step 2020).

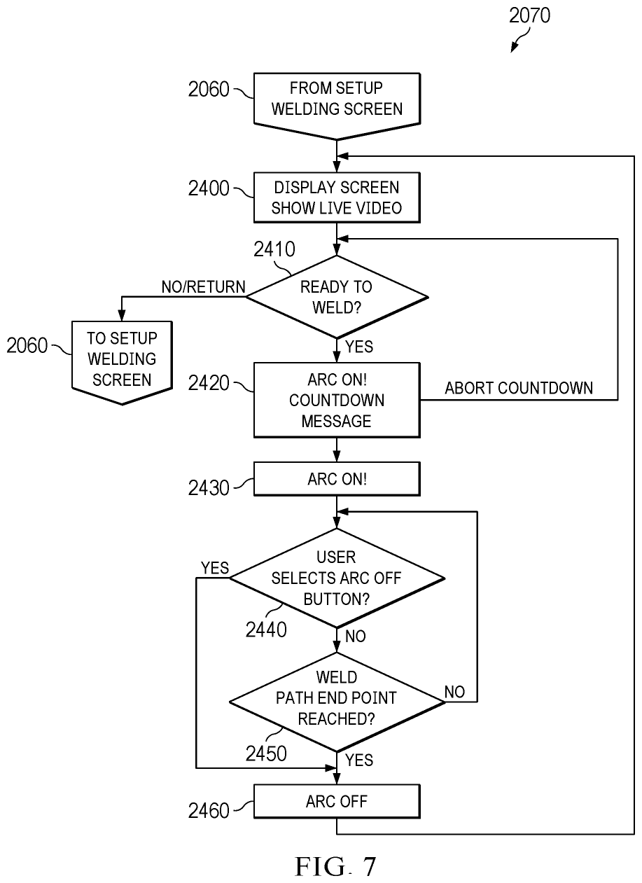

FIG. 7 is a flowchart depicting process 2070 conducting a live welding process. After the software directs the local user from the welding setup screen (step 2060) to the live welding screen at step 2070, the display screen shows live video of the welding environment at step 2400. The software again queries whether the user is ready to weld at step 2410. If not ready, the software returns the user to the welding setup screen (step 2060). If ready, an “Arc ON!” countdown message is displayed to the user at step 2420. The user may abort countdown and return the process to step 2410. If the user does not abort countdown, a welding arc turns on at step 2430 and the robot performs its programmed weld path. If the user selects the “welding arc off” button at step 2440, the welding arc turns off at step 2460. Otherwise, the software keeps the welding arc on until the end point of the robot's weld path is reached at step 2450. The software automatically turns welding arc off at step 2460 once the robot's weld path end point is reached and returns the user to step 2400.

All literature and similar material cited in this application, including, but not limited to, patents, patent applications, articles, books, treatises, and web pages, regardless of the format of such literature and similar materials, are expressly incorporated by reference in their entirety. Should one or more of the incorporated references and similar materials differ from or contradict this application, including but not limited to defined terms, term usage, described techniques, or the like, this application controls.

As previously stated and as used herein, the singular forms “a,” “an,” and “the,” refer to both the singular as well as plural, unless the context clearly indicates otherwise. The term “comprising” as used herein is synonymous with “including,” “containing,” or “characterized by,” and is inclusive or open-ended and does not exclude additional, unrecited elements or method steps. Although many methods and materials similar or equivalent to those described herein can be used, particular suitable methods and materials are described herein. Unless context indicates otherwise, the recitations of numerical ranges by endpoints include all numbers subsumed within that range. Furthermore, references to “one implementation” are not intended to be interpreted as excluding the existence of additional implementations that also incorporate the recited features. Moreover, unless explicitly stated to the contrary, implementations “comprising” or “having” an element or a plurality of elements having a particular property may include additional elements whether or not they have that property.

The terms “substantially” and “about”, if or when used throughout this specification describe and account for small fluctuations, such as due to variations in processing. For example, these terms can refer to less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%, and/or 0%.

Underlined and/or italicized headings and subheadings are used for convenience only, do not limit the disclosed subject matter, and are not referred to in connection with the interpretation of the description of the disclosed subject matter. All structural and functional equivalents to the elements of the various implementations described throughout this disclosure that are known or later come to be known to those of ordinary skill in the art are expressly incorporated herein by reference and intended to be encompassed by the disclosed subject matter. Moreover, nothing disclosed herein is intended to be dedicated to the public regardless of whether such disclosure is explicitly recited in the above description.

There may be many alternate ways to implement the disclosed technology. Various functions and elements described herein may be partitioned differently from those shown without departing from the scope of the disclosed technology. Generic principles defined herein may be applied to other implementations. Different numbers of a given module or unit may be employed, a different type or types of a given module or unit may be employed, a given module or unit may be added, or a given module or unit may be omitted.

Regarding this disclosure, the term “a plurality of” refers to two or more than two. Unless otherwise clearly defined, orientation or positional relations indicated by terms such as “upper” and “lower” are based on the orientation or positional relations as shown in the figures, only for facilitating description of the disclosed technology and simplifying the description, rather than indicating or implying that the referred devices or elements must be in a particular orientation or constructed or operated in the particular orientation, and therefore they should not be construed as limiting the disclosed technology. The terms “connected”, “mounted”, “fixed”, etc. should be understood in a broad sense. For example, “connected” may be a fixed connection, a detachable connection, or an integral connection; a direct connection, or an indirect connection through an intermediate medium. For an ordinary skilled in the art, the specific meaning of the above terms in the disclosed technology may be understood according to specific circumstances.

Specific details are given in the above description to provide a thorough understanding of the disclosed technology. However, it is understood that the disclosed embodiments and implementations can be practiced without these specific details. For example, circuits can be shown in block diagrams in order not to obscure the disclosed implementations in unnecessary detail. In other instances, well-known circuits, processes, algorithms, structures, and techniques can be shown without unnecessary detail in order to avoid obscuring the disclosed implementations.

Implementation of the techniques, blocks, steps and means described above can be accomplished in various ways. For example, these techniques, blocks, steps and means can be implemented in hardware, software, or a combination thereof. For a hardware implementation, the processing units can be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above, and/or a combination thereof.

The disclosed technology can be described as a process which is depicted as a flowchart, a flow diagram, a data flow diagram, a structure diagram, or a block diagram. Although a flowchart can describe the operations as a sequential process, many of the operations can be performed in parallel or concurrently. In addition, the order of the operations can be re-arranged. A process is terminated when its operations are completed, but could have additional steps not included in the figure. A process can correspond to a method, a function, a procedure, a subroutine, a subprogram, etc. When a process corresponds to a function, its termination corresponds to a return of the function to the calling function or the main function.

Furthermore, the disclosed technology can be implemented by hardware, software, scripting languages, firmware, middleware, microcode, hardware description languages, and/or any combination thereof. When implemented in software, firmware, middleware, scripting language, and/or microcode, the program code or code segments to perform the necessary tasks can be stored in a machine readable medium such as a storage medium. A code segment or machine-executable instruction can represent a procedure, a function, a subprogram, a program, a routine, a subroutine, a module, a software package, a script, a class, or any combination of instructions, data structures, and/or program statements. A code segment can be coupled to another code segment or a hardware circuit by passing and/or receiving information, data, arguments, parameters, and/or memory contents. Information, arguments, parameters, data, etc. can be passed, forwarded, or transmitted via any suitable means including memory sharing, message passing, ticket passing, network transmission, etc.

It should be appreciated that all combinations of the foregoing concepts and additional concepts discussed in greater detail herein (provided such concepts are not mutually inconsistent) are contemplated as being part of the disclosed technology. In particular, all combinations of claimed subject matter appearing at the end of this disclosure are contemplated as being part of the technology disclosed herein. While the disclosed technology has been illustrated by the description of example implementations, and while the example implementations have been described in certain detail, there is no intention to restrict or in any way limit the scope of the appended claims to such detail. Additional advantages and modifications will readily appear to those skilled in the art. Therefore, the disclosed technology in its broader aspects is not limited to any of the specific details, representative devices and methods, and/or illustrative examples shown and described. Accordingly, departures may be made from such details without departing from the spirit or scope of the general inventive concept.

What is claimed:

1. A method for switching between operational modes in a tele-manufacturing system, comprising:
(a) providing a tele-manufacturing system that includes manufacturing equipment and at least one sensor positioned in a manufacturing environment, at least one manual controller that receives motion input from a user of the manual controller, and at least one processor with control software that mathematically transforms the motion input into corresponding motion commands that are sent to the manufacturing equipment;
(b) connecting the at least one processor to the manufacturing equipment and the at least one manual controller; and
(c) configuring the at least one processor to:
(i) display a plurality of action choices to the user on a main screen user interface, wherein the plurality of action choices comprises:
a) activating a free form mode, wherein the free form mode enables the user to move the manufacturing equipment at will; and
b) activating a path mode, wherein the path mode directs the manufacturing equipment to perform manufacturing commands;
(ii) navigate the user to:
a) a first screen if the user chooses to activate the free form mode; and
b) a second screen if the user chooses to activate the path mode; and
(iii) automatically switch between the free form mode and the path mode.

2. The method of claim 1, wherein within the first screen, the processor is configured to:
(a) enable the free form mode upon the user's command;
(b) display real-time video data of the free form mode to the user; and
(c) direct the user to the second screen if the user chooses to activate the path mode.

3. The method of claim 2, wherein the processor directs the user back to the main screen user interface if the user does not enable the free form mode.

4. The method of claim 1, wherein within the second screen, the processor is configured to:
(a) receive the manufacturing commands and manufacturing parameter data from the user; and
(b) direct the user to a live manufacturing screen if the user is ready for the manufacturing equipment to perform the manufacturing commands.

5. The method of claim 4, wherein the processor directs the user back to the main screen user interface if the user is not ready for the manufacturing equipment to perform the manufacturing commands.

6. The method of claim 4, wherein within the live manufacturing screen, the processor is configured to:
(a) display real-time video data of the path mode to the user;
(b) activate the manufacturing equipment in the manufacturing environment; and
(c) deactivate the manufacturing equipment when a manufacturing end-point is reached.

7. The method of claim 6, wherein the processor displays a countdown to the user before activating the manufacturing equipment in the manufacturing environment.

8. The method of claim 7, wherein the user can selectively abort the countdown and prevent the processor from activating the manufacturing equipment.

9. The method of claim 1, wherein the plurality of action choices further comprises changing the at least one manual controller.

10. The method of claim 9, wherein the processor is further configured to navigate the user to a third screen if the user chooses to change the at least one manual controller.

11. The method of claim 10, wherein within the third screen, the processor is configured to:
(a) display all available manual controller options to the user;
(b) receive user selection of a new manual controller from the available manual controller options;
(c) connect the new manual controller to the processor; and
(d) direct the user back to the main screen user interface once the new manual controller is connected.

12. The method of claim 11, wherein the processor directs the user back to the main screen user interface if the user chooses not to change the selected manual controller.

13. The method of claim 1, wherein the manufacturing equipment includes welding equipment.

14. A method for switching between operational modes in a tele-manufacturing system, comprising:
(a) providing a tele-manufacturing system that includes manufacturing equipment and at least one sensor positioned in a manufacturing environment, at least one manual controller that receives motion input from a user of the manual controller, and at least one processor with control software that mathematically transforms the motion input into corresponding motion commands that are sent to the manufacturing equipment; and
(b) connecting the at least one processor to the manufacturing equipment and the at least one manual controller, wherein the at least one processor is configured to:
(i) display a plurality of action choices to the user on a main screen user interface, wherein the plurality of action choices comprise:
a) activating a free form mode, wherein the free form mode enables the user to move the manufacturing equipment at will;
b) activating a path mode, wherein the path mode directs the manufacturing equipment to perform manufacturing commands; and
c) changing the at least one manual controller;
(ii) navigate the user to:
a) a first screen if the user chooses to activate the free form mode;
b) a second screen if the user chooses to activate the path mode; and
c) a third screen if the user chooses to change the at least one manual controller; and
(iii) automatically switch between the free form mode and the path mode.

15. The method of claim 14, wherein within the first screen, the processor is configured to:
(a) enable the free form mode upon the user's command;
(b) display real-time video data of the free form mode to the user; and
(c) direct the user to the second screen if the user chooses to activate the path mode.

16. The method of claim 14, wherein within the second screen, the processor is configured to:
(a) receive the manufacturing commands and manufacturing parameter data from the user; and
(b) direct the user to a live manufacturing screen if the user is ready for the manufacturing equipment to perform the manufacturing commands.

17. The method of claim 16, wherein within the live manufacturing screen, the processor is configured to:
(a) display real-time video data of the path mode to the user;
(b) activate the manufacturing equipment in the manufacturing environment; and
(c) deactivate the manufacturing equipment when a manufacturing end-point is reached.

18. The method of claim 17, wherein the processor displays a countdown to the user before activating the manufacturing equipment in the manufacturing environment.

19. The method of claim 14, wherein within the third screen, the processor is configured to:
(a) display all available manual controller options to the user;
(b) receive user selection of a new manual controller from the available manual controller options;
(c) connect the new manual controller to the processor; and
(d) direct the user back to the main screen user interface once the new manual controller is connected.

20. The method of claim 1, wherein the manufacturing equipment includes welding equipment.
